(19) United States
(12) Patent Application Publication
(10) Pub. No.: US 2019/0316514 A1
(43) Pub. Date: Oct. 17, 2019

(54) Device For Supercharging An Internal Combustion Engine

(71) Applicant: MAN ENERGY SOLUTIONS SE, Augsburg (DE)

(72) Inventors: Jan-Christoph HAAG, Hirschberg (DE); Lutz AURAHS, Langweid (DE); Klaus BARTHOLOMÄ, Friedberg (DE)

(73) Assignee: MAN ENERGY SOLUTIONS SE

(21) Appl. No.: 16/385,639

(22) Filed: Apr. 16, 2019

(30) Foreign Application Priority Data
Apr. 17, 2018 (DE) 102018109010.2

(51) Int. Cl. F02B 33/36; B60K 6/485; B60K 6/12; F02B 37/10

(52) U.S. Cl. CPC F02B 33/36; B60K 6/485; B60Y 2400/435; F02B 37/10; B60K 6/12

(57) ABSTRACT

A supercharging device for an internal combustion engine having a compressor that is driven by an electric motor for supercharging the internal combustion engine with air via an air feed passage, and an electric energy accumulator, which is fed with electric energy via a first power generator that is driven by the internal combustion engine. The energy supply the electric motor is connected to electric energy stored in the energy accumulator to drive the compressor independently of a current operating point on a power curve of the internal combustion engine.

### BACKGROUND OF THE INVENTION

### 1. Field of the Invention

The invention relates to a device for supercharging an internal combustion engine, preferentially an internal combustion engine in a hybrid drive system.

### 2. Description of the Related Art

A wide range of configurations of supercharging systems are known from the prior art. From DE 10 2016 107870 A1 a method for operating an internal combustion engine with at least one high-pressure exhaust gas turbocharger comprising at least one high-pressure exhaust gas turbine with variable turbine geometry and a high-pressure compressor and at least one low pressure exhaust gas turbocharger comprising a low pressure exhaust gas turbine with variable turbine geometry and a low pressure compressor.

WO 2016074752 A relates to a supercharging device for an internal combustion engine with a compressor that delivers fluid from a suction side towards a pressure side in the process compressing it from a first pressure that is present on the suction side to a second pressure that is present on the pressure side. Here it is provided that between the pressure side and the suction side a bypass line is provided in a housing of the supercharging device, in which a suction jet pump with an underpressure connection is present.

Such internal combustion engines that are supercharged via an exhaust gas turbocharger or exhaust gas compressor generally have the disadvantage that do to the exhaust gas turbocharger a more or less pronounced power offset or turbo lag occurs at the start during an increase of the power of the internal combustion engine (e.g. when accelerating a drive motor).

However, a state in which when accelerating the compressor immediately supercharges the internal combustion engine is desirable to avoid this initial turbo lag or power offset.

### SUMMARY OF THE INVENTION

Accordingly, one aspect of the present invention is based on overcoming the aforementioned disadvantages and create a supercharging device for an internal combustion engine that has an improved operating behaviour in particular when increasing load and ensures an efficient air supply and accordingly immediate supercharging of the internal combustion engine even at different operating points of the engine.

A first basic idea of the invention is to ensure a faster provision of air when increasing load in that the required supercharging is effected via an electrically driven compressor independent of the operating point of the internal combustion engine and its current load state at the time, thus independent of the exhaust gas flow that happens to be generated at the time. A second aspect of the invention relates to the energy supply of the electric drive of the compressor, which is likewise effected load-independent of the current operating state at the time, in that an energy buffer is provided, from which the necessary electric energy for the electric motor is obtained even when the internal combustion engine is accelerated quasi from the stationary state.

According to one aspect of the invention, a supercharging device for an internal combustion engine having a variable power curve is proposed for this purpose, wherein the supercharging device comprises a compressor that is electrically driven by an electric motor for supercharging the internal combustion engine with air via an air feed passage and an electric energy accumulator, which is fed with electric energy via a first power generator that is driven (or driveable) via an internal combustion engine, wherein for the energy supply the electric motor is connected to an electric energy stored in the energy accumulator in order to drive the compressor independently of the current operating point on the power curve at the time of the internal combustion engine.

It is preferred that the first power generator is a generator that is driven via a mechanical output of the internal combustion engine. By way of this, the energy extracted from the energy accumulator can be recharged so that the energy accumulator always has sufficient energy accumulated to supply the electric motor of the compressor with energy.

It is advantageous, furthermore, when in addition a second power generator is provided, which for the energy generation by an exhaust gas flow of the internal combustion engine is indirectly connected via a mechanical coupling to a mechanical device that is driveable by the exhaust gas flow. It is particularly advantageous when the second power generator is likewise a generator.

In a preferred configuration of the invention the first generator is designed as a shaft generator that is directly connected to the output of the internal combustion engine via a gear stage.

In a further advantageous configuration of the invention the device that is driveable by the exhaust gas flow of the internal combustion engine is a turbine (e.g. an exhaust gas turbine) that is drive-effectively connected to the second generator in such a manner that during the rotation of the turbine the second power generator is mechanically driven for generating electric energy and this energy is made available either for the energy accumulator or alternatively for electrical consumers. For this purpose, a suitable control can be provided which controls the energy flow of the electric energy to those components that are connected to the power generator.

In a further development of the invention the turbine is also connectable or connected to the first generator in a drive-effective manner. Accordingly, at a low rotational speed of the internal combustion engine but in the presence of an exhaust gas flow the latter can be utilised to drive the generator.

It is particularly advantageous when, furthermore, a regulating and control device is provided, which dependent on the respective current operating point of the internal combustion engine at the time controls the energy flow namely to the extent to which the first and/or the second power generator can feed the respective currently generated electric energy to the electric energy accumulator and the respective remaining amount of energy is available for an energy sink or a consumer thus, engine load-dependently for other purposes. With efficient control, the conventional alternator in an application in a vehicle or transport can be completely omitted for the energy supply of the consumers and the necessary energy accessed from the generator of the supercharging device or the energy accumulator.

A further aspect of the invention relates to a system consisting of an internal combustion engine and a supercharging device as described above, wherein the internal combustion engine is drive-effectively connected to at least the or a first power generator and/or indirectly via drive components that are connected in between to the or a second power generator. It is particularly advantageous when the system is a hybrid system in which the internal combustion engine represents a drive component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are characterized in the subclaims and together with the description of the preferred embodiment of the invention are shown in more detail by way of the figures.

It shows:

FIG. 1 is a supercharging device; and

FIG. 2 is a supercharging device.

### DETAILED DESCRIPTION OF THE PRESENTLY PREFERRED EMBODIMENTS

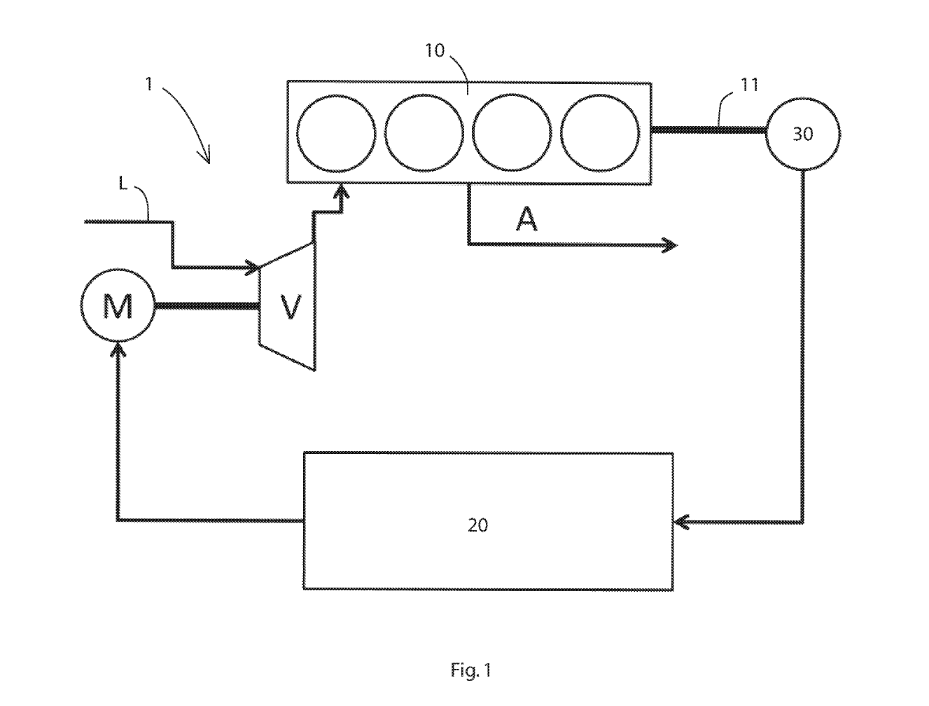

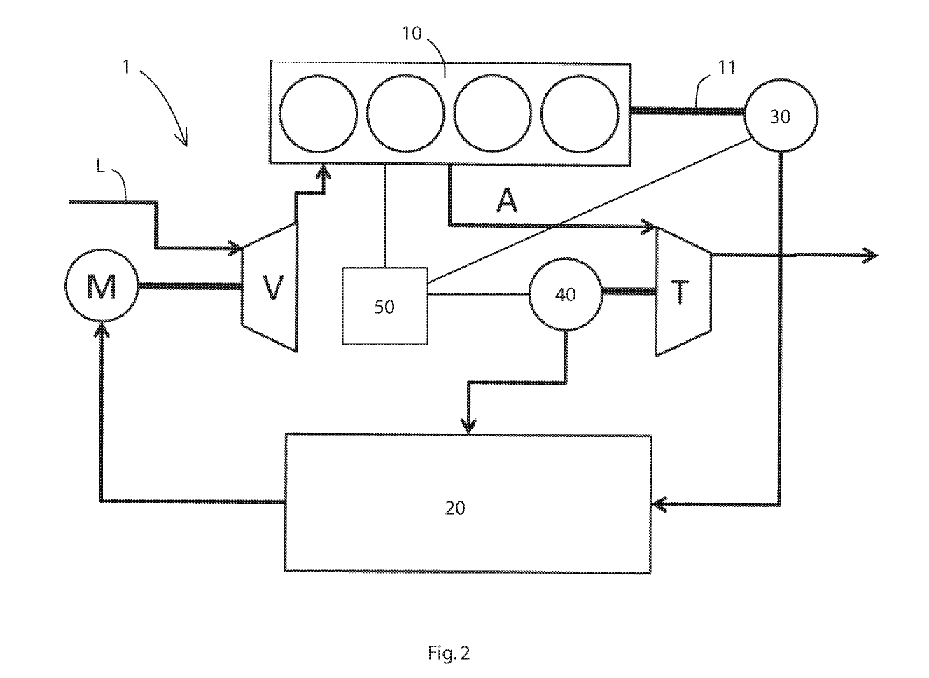

The invention is explained in more detail by way of exemplary embodiments making reference to the FIGS. 1 and 2. In FIGS. 1 and 2, two different embodiments of a supercharging device according to aspects of the invention are shown, wherein the same reference characters relate to same structural or functional features.

In FIG. 1, a first embodiment of a supercharging device 1 according to the invention or a system consisting of such a supercharging device 1 with an internal combustion engine 10 is shown.

As is evident from FIG. 1, the supercharging device 1 is provided for an internal combustion engine 10. The internal combustion engine 10 in this case represents an internal combustion engine in a hybrid drive system, wherein the internal combustion engine 10 can be operated at different load points along its power curve. When the internal combustion engine 10 is in a load-free state the internal combustion engine generates only a minor exhaust gas flow A. However, in the embodiment shown in FIG. 1 the exhaust gas flow A is not used for driving a compressor. The shown compressor V is rather used for compressing air drawn in on the inlet side via a feed passage L and to feed the air for supercharging the internal combustion engine 10 to the same.

Here, the compressor V is not designed as an exhaust gas turbocharger but as a compressor V that is electrically driven by an electric motor M. The electric motor M is connected to an electric energy accumulator 20 in order to be supplied with electric energy by the same.

Furthermore, a first power generator 30 that is driven by the internal combustion engine 10 is provided to charge the energy accumulator 20.

Since the electric motor M receives its energy required for the drive directly from the electric energy accumulator 20 it is possible to drive the compressor V independently of the current load or operating point of the combustion engine 10 at a given time and thus independently of the exhaust gas flow A of the internal combustion engine 10. Thus, the compressor V can develop its full air output even in the lower output range of the internal combustion engine 10 and immediately when the compressor V is accelerated, which by an exhaust gas turbocharger is only possible with a certain power offset.

The first power generator 30 in this exemplary embodiment is a shaft generator that is driven via a mechanical output 11, namely via a driveshaft of the internal combustion engine 10.

In the alternative embodiment of FIG. 2, a second power generator 40, in this case likewise a power generator is provided, which for generating energy by an exhaust gas flow A of the internal combustion engine 10 is indirectly driven via an exhaust gas turbine T by way of a mechanical coupling. Here, the generator 40 feeds electric energy to the energy accumulator 20.

Accordingly, in the exemplary embodiment as per FIG. 2, energy can be generated for the energy accumulator 20 for operating the compressor V via the first and also the second generator 30, 40.

In this version, a regulating and control device 50 is provided which dependent on the respective current operating point of the internal combustion engine 10 controls the energy flow of the generators 30, 40. Here the control operates so that the extent is determined to which the first and/or the second generator 30, 40 can feed the respective currently generated electric energy to the electric energy accumulator 20 and the respective remaining energy amount is available for an energy sink or an external consumer and thus dependent on the engine load.

In its embodiment, the invention is not restricted to the preferred exemplary embodiments stated above. A number of versions are rather conceivable which makes use of the shown solution even with fundamentally different types of embodiments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A supercharging device for an internal combustion engine with a variable power curve comprising:
an electric motor
a compressor that is electrically driven by the electric motor for supercharging the internal combustion engine with air via an air feed passage;
a first power generator driven by the internal combustion engine; and
an electric energy accumulator, which is fed with electric energy via the first power generator,
wherein for an energy supply the electric motor is connected to electric energy stored in the electric energy accumulator to drive the compressor independently of a current load or an operating point on the variable power curve of the internal combustion engine at a time.

2. The supercharging device according to claim 1, wherein the first power generator is a generator driven via a mechanical output of the internal combustion engine.

3. The supercharging device according to claim 1, further comprising:
a mechanical device that is driveable by an exhaust gas flow; and
a second power generator configured for energy generation by the exhaust gas flow of the internal combustion engine that is indirectly connected via a mechanical coupling to the mechanical device.

4. The supercharging device according to claim 3, wherein the second power generator is a generator.

5. The supercharging device according to claim 2, wherein the first power generator is a shaft generator directly connected to an output of the internal combustion engine via a gear stage.

6. The supercharging device according to claim 3, wherein the mechanical device that is driveable by the exhaust gas flow of the internal combustion engine is a turbine, which is drive-effectively connected to the second power generator such that when the turbine is rotated, the second power generator is mechanically driven for generating electric energy.

7. The supercharging device according to claim 6, wherein the turbine is drive-effectively connectable or connected to the first power generator.

8. The supercharging device according to claim 3, further comprising:
a regulating and control device, which dependent on a respective current operating point of the internal combustion engine controls an extent to which the first and/or the second power generator feeds a respective currently generated electric energy to the electric energy accumulator and a respective remaining energy amount is dependent on engine load available for an energy sink or a consumer.

9. A system comprising:
an internal combustion engine; and
a supercharging device comprising:
an electric motor
a compressor that is electrically driven by the electric motor for supercharging the internal combustion engine with air via an air feed passage;
a first power generator driven by the internal combustion engine;
an electric energy accumulator, which is fed with electric energy via the first power generator;
a mechanical device that is driveable by an exhaust gas flow; and
a second power generator configured for energy generation by the exhaust gas flow of the internal combustion engine that is indirectly connected via a mechanical coupling to the mechanical device
wherein for an energy supply the electric motor is connected to electric energy stored in an energy accumulator to drive the compressor independently of a current load or an operating point on a variable power curve of the internal combustion engine at a time,
wherein the internal combustion engine is drive-effectively connected to at least the first power generator and/or the second power generator indirectly via drive components connected in between.

10. The system according to claim 9, wherein the system is a hybrid drive system in which the internal combustion engine represents one of the drive components.
